(19) United States
(12) Patent Application Publication
(10) Pub. No.: US 2015/0237840 A1
(43) Pub. Date: Aug. 27, 2015

(54) PAD-LIKE SUPPORT DEVICE

(71) Applicant: SVENSKA ELITSKON AB, UPPSALA (SE)

(72) Inventor: Erik Lundqvist, Stocke (SE)

(73) Assignee: SVENSKA ELITSKON AB, UPPSALA (SE)

(21) Appl. No.: 14/431,220

(22) PCT Filed: Sep. 26, 2013
(86) PCT No.: PCT/SE2013/000148

§ 371 Date: Mar. 25, 2015

(30) Foreign Application Priority Data
Sep. 27, 2012 (SE) SE1200581-5

(51) Int. Cl. A01L 7/02

(52) U.S. Cl. CPC A01L 7/02

(57) ABSTRACT

The present invention concerns a pad-like support device (1) intended to be attached between a horse's hoof (2) and a horseshoe (3) comprised of at least one first side part (6), at least one second side part (7), at least one middle part (8) and a support section (9) for the frog, and at least one first flexible zone (10) and at least one second flexible zone (11) extending essentially along the pad-like support device's longitudinal direction. This design allows for the support section (9) and the middle part (8) to be flexibly arranged in the horizontal and vertical directions relative to the first side part (6) and the second side part (7). The first side part (6) and the second side part (7) include at least one first material layer (29) constituting a surface layer on the topside of the side parts (6, 7) and at least one second material layer (30) constituting a surface layer on the bottom side of the side parts (6, 7) and at least one intermediate material layer (31) positioned between the first material layer (29) and the second material layer (30) of a relatively softer material than the material of the first material layer (29) and the second material layer (30). Material layer (31) is partitioned into at least two sections (34) by at least one intermediate wall (35) that stretches between the first material layer (29) and the second material layer (30).

### FIELD OF THE INVENTION

The present invention concerns a pad-like support device in accordance with the claims.

### BACKGROUND OF THE INVENTION

Horses have evolved over millions of years and have adapted in relation to their natural way of life and the wild habitats they have lived in. The natural evolution of horses has led to their hooves, although they feel hard and seem to lack flexibility, including parts that are mutually movable relative to each other. The anatomical structure of hooves with movable hoof parts helps to dampen strain during impact (contact) with the ground, reduces the risk of a horse spraining itself and increases fluid (blood) circulation in the hoof and legs. FIG. 1A shows schematically a bottom view a horse hoof's elemental parts. A horse hoof consists essentially of a toe 101, two hoof walls 102 and 103, a sole 104, a frog 105, angle of walls 106 and 107 as well as bars 108 and 109. A hoof also includes a shock absorbing digital cushion 110. The parts of a horse's hoof parts move relative to each other during a hoof's impact (ground contact) phase, stance (load) phase and breakover (acceleration) phase.

FIGS. 1B-1D show how a horse hoof's parts change position relative to each other during a hoof's impact phase and stance phase. When a hoof makes ground contact during the impact phase as well as when load is applied during the stance phase, the walls 102 and 103 are affected by the digital cushion's 110 change in shape, caused by the frog's 105 pressure against the digital cushion 110, to move away from one another in the horizontal direction.

During the stance phase, even the sole 104 moves in a vertical direction downward thereby creating ground contact (traction).

In the wild the horse itself chooses where it wants to go and on what surface it wants to tread on. Since the taming of horses by humans, horses have for example been used as working animals, riding animals and the like. This results in people controlling where a horse goes and on what type of terrain the horse must tread on, respectively. For horses, this has resulted in a higher load and a higher wear on horses' hooves than horses in the wild have been subjected to. For example, riding and racing horses' hooves are exposed to high levels of load and wear during exercise and competition. Normally, a hoof impacts about 2800 times in a harness race, and more than 30000 times during a normal training session. In order to reduce wear on the hooves, different types of horseshoes which are attached to the hoof with some type of seam (nails, glue), have been developed. Horseshoes are usually of rigid design and manufactured from steel or other type of metal. A horseshoe's rigidity leads to the previously mentioned natural movements of the parts of the hoof being prevented, or at least more obstruct. Because a horseshoe also raises the hoof a bit above the underlying surface, the hoof's frog does not receive the necessary contact with the ground. When an unshod horse's hoof touches ground, natural mechanical forces occur in the hoof by way of both the frog and the short pastern bone. These forces press the frog upward from below and provide pressure against the elastic digital cushion, at the same time the short pastern bone presses against the digital cushion from above by the horse's weight. Together, these forces compel the digital cushion to widen horizontally pushing apart the hoofs walls. The hoof's widening movement is made possible thanks to the rear of the hoof being open and comprised of an elastic tissue (frog). When a horse is shod a space is created between the frog and the underlying surface (see FIG. 1F). This entails that the frog's purpose during impact is for the most part not achieved which leads to the primary shock during hoof impact being absorbed through the hoof walls and inward toward bones and joints without first being cushioned. This results in the horse being afflicted by different types of health problems such as lameness and other ailments.

A large number of different kinds of pads, designed to be mounted between the hoof and the horseshoe have been developed to further reduce the load and wear on a horse's hooves. Pads are used for example if the ground is hard, rocky or similar. If a horse has sensitive hooves, it is common practice to use pads to protect the hoof. Special pads, so-called snow pads, are also used in winter to reduce the risk of snowballs (ice clumps) and the like from forming under the hoof. Pads are also used in situations where it is desirable to modify a horse's step (gait). Today, pads are used for both racing and riding.

Current pads have several problems. For example, they have inadequate elasticity in the horizontal direction. This means that the central section as well as the frog area of the pad does not, to any great extent, allow movement relative to the pads' side parts where the pads are attached with seams (nails) to the hoof. The fact that pads have a limited horizontal elasticity means for example that bumps on the ground where impact occurs will push (press) the pad into the cavity that is naturally present under the hoof while the frog presses the pads rear part down. This results in the creation of tensile forces in the pad, which pulls at the seams (nails) (essentially in their transverse directions) also causing the shoe to start loosening. There is also a risk that the shoe may shear off the seams (nails) causing the shoe to detach.

Known designs of pads also have the problem that they do not provide pressure against the frog. This in turn means that the frog moves relative to the pad thereby allowing heating to occur from the movement and friction between the frog and pad. Heat can damage the tissue of the frog.

Existing types of pads also have the problem that they have a low resistance (durability) to wear. The horse's weight and hoof mechanism's movement results in the pads wearing out quickly in the rear and central parts. The hoof and shoe then get caught in the worn down depressions, and the hoof mechanism's natural motion is put out of play. Furthermore, this short lifetime results in the horse needing to be shod more often, which is costly.

There is also a problem with the pads oozing out (squeezing, pressing out) between the hoof and the horseshoe during the compression of the pad in connection with hoof impact and gait.

Horseshoes and existing pads may also lead to the deterioration of the mechanical pump mechanism that occurs naturally in the hoof and thereby also impair circulation in the hoof.

Another problem with existing designs of pads which are to be used in combination with horseshoes is the space at the rear edge of the shoe. The problem consists of providing suitable support for the different parts of the hoof while also minimizing the risk of the pad being stretched apart by the normal movement of the hoof.

### PRIOR ART

A number of pad-like designs intended to be placed between a horseshoe and a horse's hoof are previously known. For example, a type of pad for horses which includes a support section for a hoof's frog is described in U.S. Pat. No. 6,672,395. This design does not include flexible zones in accordance with the present invention. Therefore this design has the previously stated problems. Consequently this design differs greatly from the present invention's design.

WO2006002623 describes a type of pad for horses intended for placement between the horseshoe and horse's hoof. This pad includes at its rear a radial groove which limits shock in the impact phase and the stance phase. This design differs substantially from the design in accordance with the present patent application.

GB254386 describes a variant of a pad, which is designed to be removable in relation to the horse's hoof. The design includes a wedge-shaped (tapered) support section for the hoof's frog. In other aspects, the design in accordance with GB254386 differs greatly from the present invention's design.

The German design patent DE202008012227U1 describes a type of hoof boot (bell boot) which includes a portion located at the frog's position. This design differs greatly from the present invention's design.

DE69817417 describes a variant of a pad for a horse. The design according to its description primarily functions as a thin pad with protruding parts. This design according to its description essentially lacks the flexibility when compared with the design according to the present patent application. The design described in DE69817417 differs substantially from the design in accordance with the present patent application. For example the design does not include bellow-like flexible zones which results in the design not being able to solve the same problems as the design in accordance with the present patent application. The design according to DE69817417 is for example not able to flex in the vertical direction without wrenching (twisting) occurring.

U.S. Pat. No. 4,513,825 describes a variant of a pad intended to be used between a horse hoof and a horseshoe. This design differs substantially from the design in accordance with the present patent application. For example the design according to its description lacks a flexibility that would prevent the pad being stretched apart.

European patent application 10820895.0 describes a variant of a pad-like support device which includes a support section that via flexible zones is attached to the side parts. Even though this design may very well fulfill its purposes, there still exist problems. For example, the risk of the pad being stretched apart has not been completely eliminated with the design according to its description. The flexible zones length of elasticity is most often limited. The design lacks the features that characterize the design of the present patent application. For example, the support section in accordance with the described invention consists of one layer of material and not several layers of material such as in the design of the present patent application. Furthermore, the design according to its description lacks intermediate material layers in the side parts.

### BRIEF DESCRIPTION OF THE CONCEPT OF THE PRESENT INVENTION

The main purpose of the present invention is to substantially reduce the above mentioned drawbacks and create a significantly improved pad-like support device for a horse hoof's frog. A further purpose of the present invention is to create a pad that provides enhanced support to the horse's frog. A still further purpose of the present invention is to reduce the risk of material from the pad being squeezed out between the hoof and the horseshoe. Yet another purpose of the present invention is to provide a pad with a significantly improved dimensional stability. An additional purpose of the present invention is to create a pad with an improved ability to reduce the risk of ice formation (snowballing) under the pad.

### BRIEF DESCRIPTION OF THE DRAWINGS

In the following detailed description of the present invention, reference and references to the following figures will occur. These figures are described briefly in the following figure list.

FIG. 1A shows a horse's hoof in a view from below without a shoe.

FIG. 1B shows a horse's hoof in a view from behind without a shoe.

FIG. 1C shows a shod horse's hoof in a view from behind.

FIG. 1D-1E show schematically the frog's affect on the parts of the hoof during hoof movement.

FIG. 2 shows a shod horse's hoof with the present invention.

FIG. 3 shows the present invention's topside.

FIGS. 4 and 5 show the present invention's topside in perspective.

FIG. 6 shows the present invention's bottom side.

FIGS. 7 and 8 show via hidden contours how the material layers in alternative embodiments are divided into sections with intermediate walls.

FIGS. 9A and 9B show schematically the function of the bellow-like elastic zones.

FIG. 10 shows an alternative embodiment that includes reinforcements.

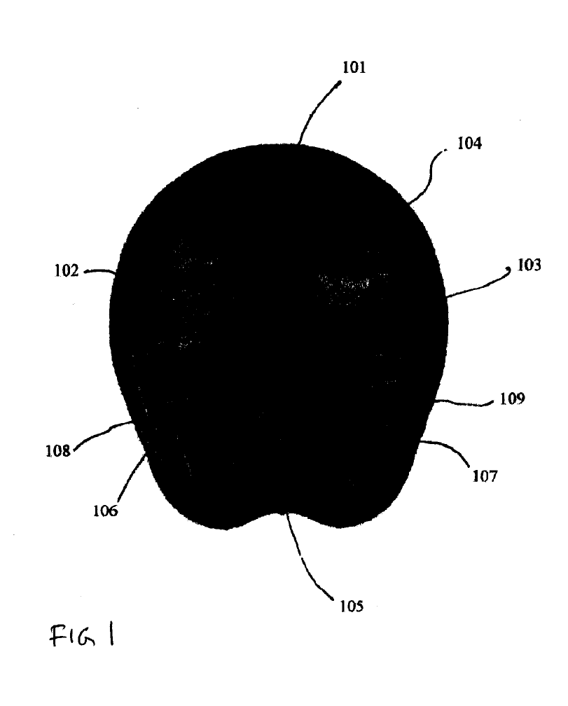

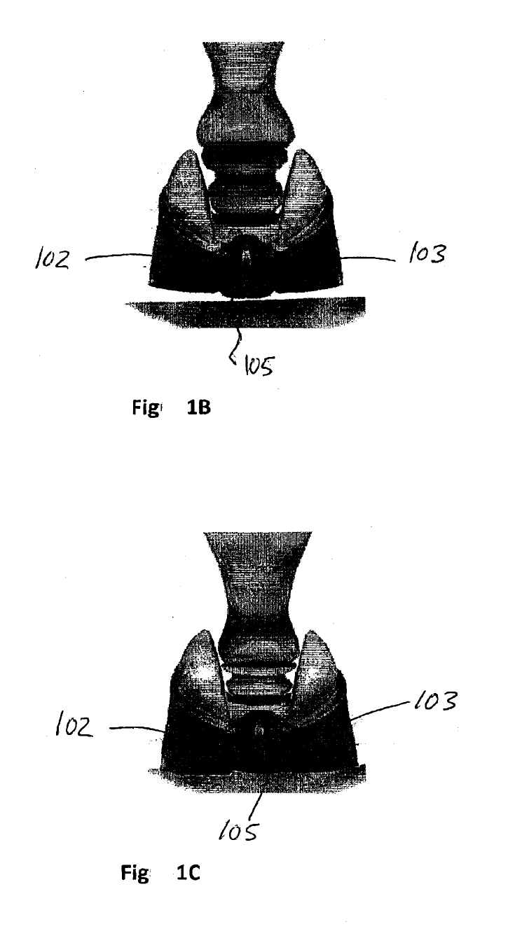

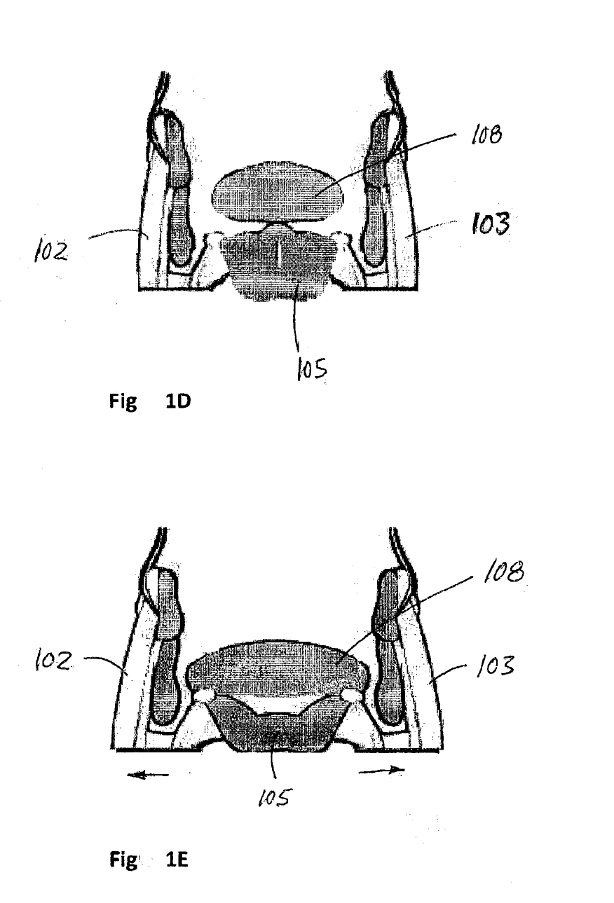

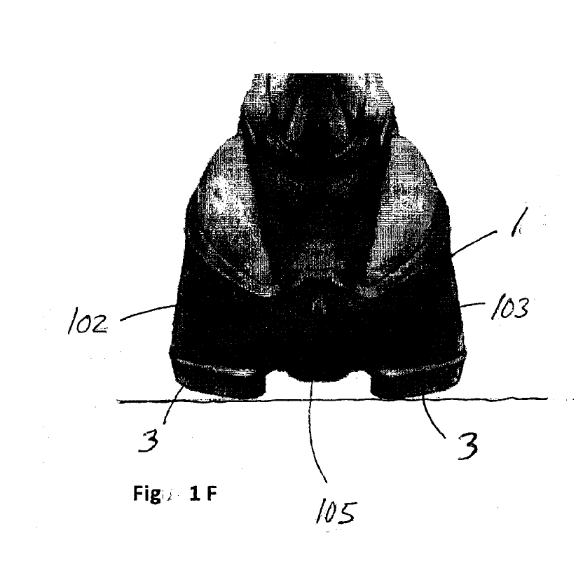

### DETAILED DESCRIPTION OF THE INVENTION

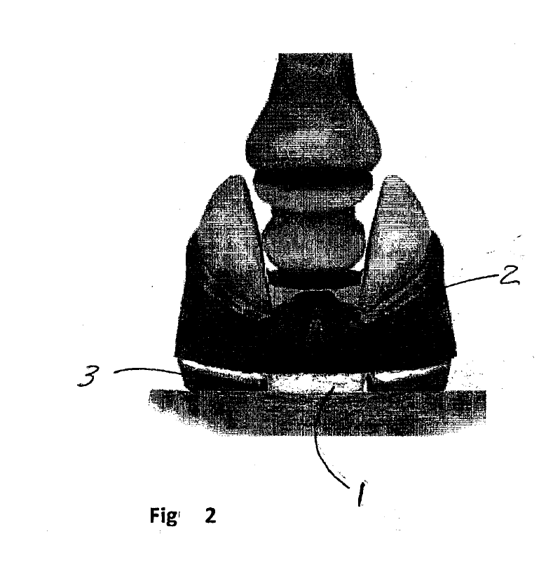

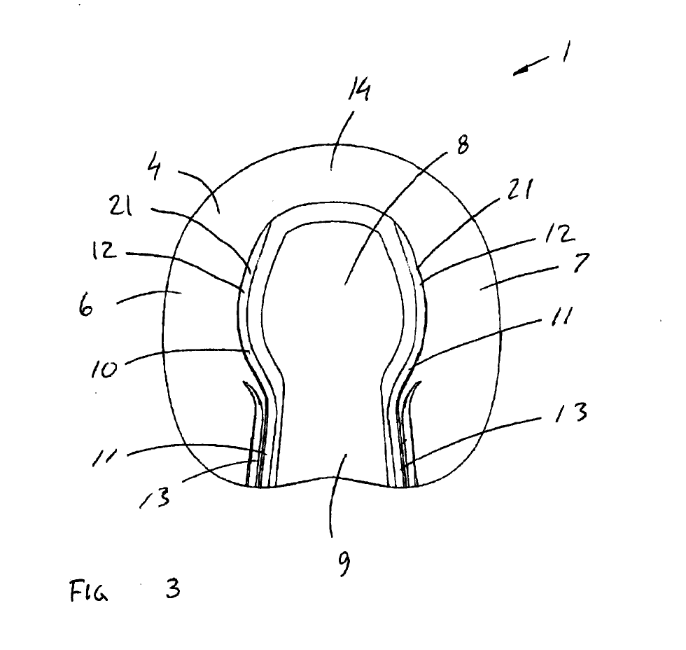

With reference to FIG. 2, a shod horse hoof is shown schematically, as seen from the back of the horse, which is equipped with a pad-like support device 1 in accordance with the present invention. The support device 1 may alternatively be referred to as the pad. In the figure the support device 1 is attached between a horse's hoof 2 and a horseshoe 3. The pad-like support device 1 is attached to the horse's hoof 2 together with the horseshoe 3 in the usual manner with seams (nails) or glue. Alternatively, the pad-like support device 1 may be attached with another for the purpose suitable method of attachment.

In the following description the terms “front part” and “front edge” of the support device and “rear part” or “rear edge” of the support device will be specified. Furthermore, the terms “topside” and “bottom side” of the support device will be designated. Use of front edge and front part means the edge, or part of the support device, that in the horizontal direction is closer to the horse's head than what the rear edge, rear part is.

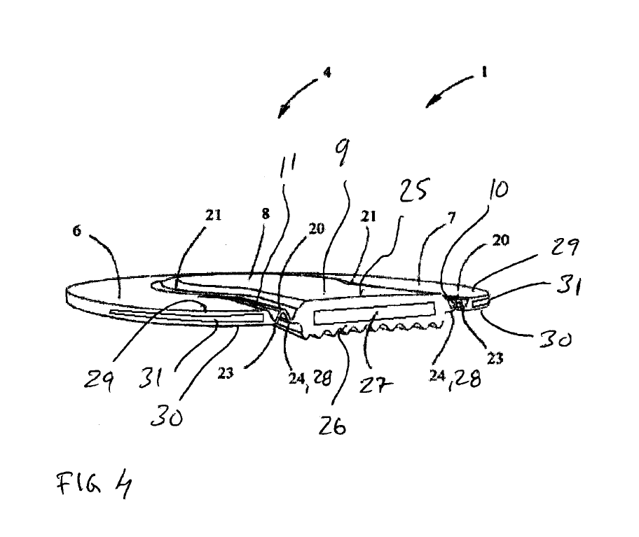

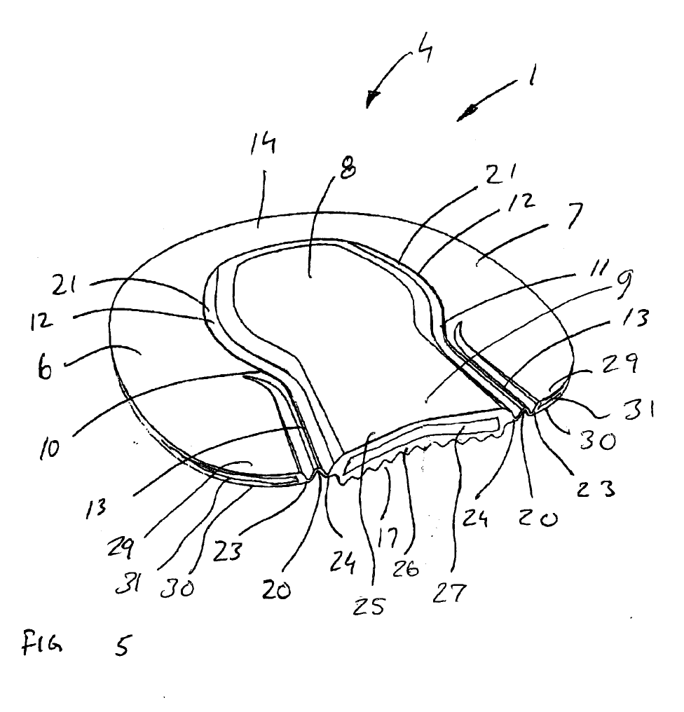

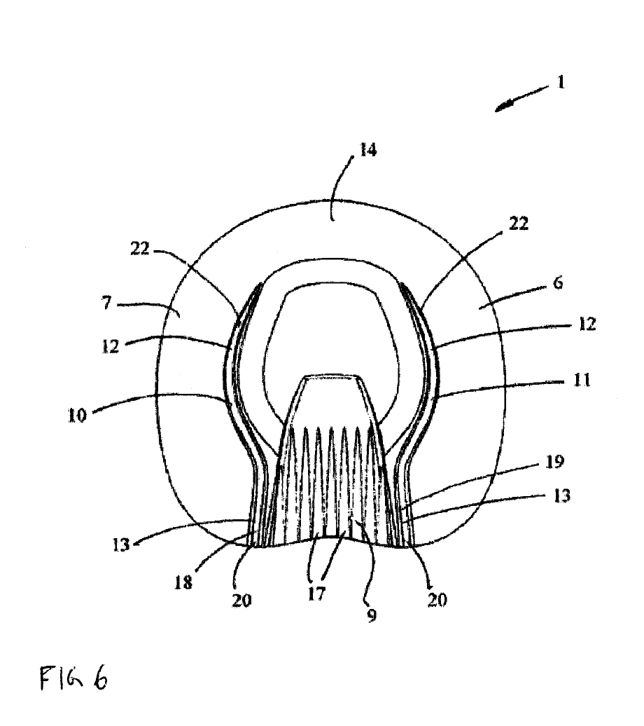

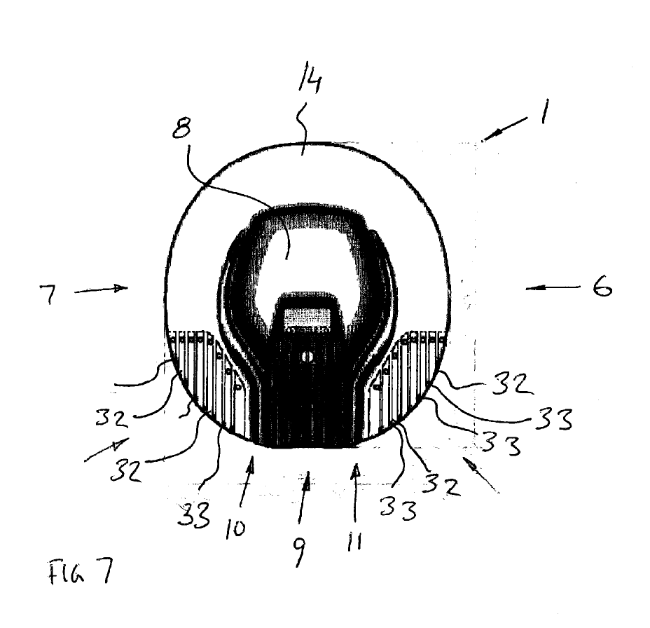

With reference to FIG. 3-10, the present support device is shown in more detail. The pad-like support device 1 has a topside 4 and a bottom side 5. The topside 4 is intended to be placed (up) against the hoof 2 and the bottom side 5 is intended to be attached (down) against the horseshoe 3.

The support device 1, according to the preferred embodiment, includes at least one first side part 6, at least one second side part 7, at least one middle part (center part) 8 and at least one support section 9 for the horse hoof's frog. Unique to the present invention is that it includes at least one first flexible zone 10 and preferably at least one second flexible zone 11. In the exemplary embodiment the first flexible zone 10 and the second flexible zone 11 each preferably include at least one front zone part 12 and at least one rear zone part 13.

The first side part 6 and the second side part 7 are connected with each other (each side part merges into the other side part) in the pad-like device's front part 14. The material of the first side part 6 and the second side part 7 is preferably, essentially wedge-shaped along its length. In alternative embodiments, it is conceivable that the first side part's 6 and the second side part's 7 thickness may vary along each side parts' length in the longitudinal or transverse direction. Furthermore, it is also conceivable that first side part 6 and the second side part 7 are of an even thickness along their length. The topside 4 of the side parts 6 and 7, facing the horse hoof's bar of wall, is of flat design. The bottom side of side parts 6 and 7 is essentially of flat design. The bottom side of side parts 6 and 7 constitutes the contact surface against the horseshoe.

In a further embodiment of the present patent application, the support device has a slight wedge shape from the support device's front edge to support device's rear edge. The pad-like support device may successively become thicker from the front edge to the rear edge. The pad-like support device's wedge shape may also be divided into sections of different wedge shapes. The present design has thus a slight wedge shape.

The pad-like support device's 1 middle part (the center part) 8 protects the hoof (the sole of the hoof) against damage from sharp and jagged objects such as rocks, glass and the like on the underlying surface. The middle part's 8 topside is preferably somewhat elevated relative to the first side part's and the second side part's topside. The middle part 8 is comprised of a substantially thinner material than the material in the side parts 6 and 7. The first flexible zone's 10 and the second flexible zone's 11 flexibility allows the middle part 8 to move in a vertical direction relative to the side parts 6 and 7. Furthermore the side parts 6 and 7 are allowed to move in a horizontal direction relative to the middle part 8. The middle part's contact and adherence with the horse hoof's sole is thus increased. The middle part's mobility allows the middle part to move downward thus creating an effective percussion to keep ice from building up under the hoof in winter. During summer the middle part's movement also allows for increased compression of soil under the horse hoof's sole whereby better hoof traction against the ground is achieved.

The support section 9, for the frog, is placed in the pad-like support device's rear part between the first side part 6 and the second side part 7. The support section consists of at least one, relative the bottom side of the first side part 6 and the bottom side of the second side part 7, downwards protruding body (pillow) 16, or the like. Support section 9 has the task of being an extension of the frog (in the vertical direction) when the horse is shod. The void (space) that is created between the frog and the ground when the horse is shod (in comparison to when the horse is not shod) is essentially filled by the support section 9. The support section 9 thereby limits or alleviates the unfavorable motion in the vertical direction that the frog receives from ground impact (when the horse is shod). Therefore support section 9 allows the frog during the hoofs ground impact to affect the digital cushion in a manner that essentially matches the manner of an unshod horse. With the pad-like support device in accordance with the present invention, a shod horse hoof essentially receives the same dampening effect that an unshod horse hoof has.

Preferably, the topside of support section 9 is essentially flat (even) and slightly elevated relative to side parts' 6 and 7 upper flat surface. Support section 9 merges in the forward direction into the middle part 8. The support section's contact surface against the ground has preferably an arc/arch-shape, round or similar form along all or part of the bottom side's (contact surface's) length. The support section 9 may in alternative embodiments be wedge-shaped, with the thicker part at the rear part of the pad-like support device and the tapered section facing the direction of the middle part (the support section's 9 thickness decreases towards the middle part 8). In alternative embodiments, the support section 9 may be of another form suitable for the purpose.

Preferably, the body (pillow) 16 on its bottom side is fitted with at least one contour which in the exemplified embodiment consists of several longitudinal grooves (tracks) 17 (in the figures nine grooves are shown) in the pad-like support device's longitudinal direction. The grooves stretch along the entire or part of the support section's length. Preferably, the height of the grooves decreases in the forward direction. In alternative embodiments, the contour may be of another for the purpose suitable contour.

A unique feature of the present invention is that it includes at least one first flexible zone 10 and preferably also at least one second flexible zone 11. The first flexible zone 10 includes at least one material layer 18 that joins the first side part 6 with the middle part (center part) 8 and the support section 9. The second flexible zone 11 includes a material layer 19 that joins the second side part 7 with the middle part (center part) 8 and the support section 9.

The flexible zones 10 and 11 stretch along all or part of the pad-like support device's length. In the exemplifying embodiment, the first flexible zone 10 and the second flexible zone 11 extend along a portion of the pad-like support device's 1 length. Preferably, the flexible zones 10 and 11 extend from the front part 14 (toe part) to the rear edge of the pad-like support device 1. Preferably, the first flexible zone 10 and the second flexible zone 11 each include a front zone part 12 and a rear zone part 13. Within the scope of the invention the length of the zones 11 and 12 may vary.

The material layer 18 of the first flexible zone 10 and the material layer 19 of the second flexible zone 11 are bellow-shaped (accordion-shaped) in the pad-like support device's 1 transverse direction. Preferably, the bellow-shaped section encompassed in the rear zone part 13 includes at least one first inverted (seen from the top side) U-shaped section 20. The bellow-shaped section included in the front zone part 12 includes at least one upright U-shaped section 21. Alternatively, one or both of the U-shaped sections 20 and 21 may have another for the purpose suitable form, such as a V-shaped section, or a section which is shaped entirely or partially as a sine wave or the like. Alternatively, the bellow-shaped material layer 18 and material layer 19 may be designed in another for the purpose suitable manner with a form suitable for the purpose.

On the bottom side 5 of the pad-like support device 1, the U-shaped section 20 included in the rear zone part mergers into a groove 22 in the front zone part 12. On the bottom side 5 of the pad-like support device 1, the U-shaped section 21, in the front zone part 12, mergers into the rear zone part 13.

The flexible zones' 10 and 11 height in the vertical direction (the U-shaped sections' height or the wave-shaped amplitude in the vertical direction) decreases essentially in the direction towards the front part 14 (the toe section). Preferably, the flexible zones are formed so that they decrease in height, in the forward direction, until they are entirely smoothed out or essentially entirely smoothed out. This design reduces the risk of flexible zones 10 and 11 staying in the extended position. The U-shaped section (flexible zone) is turned upward, the design as such, provides more vertical movement without rubbing against the rearmost part of the hoofs (and shoe's) heel buttress.

The material layer's 18 thickness in the first flexible zone 10 and the material layer's 19 thickness in the second flexible zone 11 are less (thinner) than the material thickness of the side parts 6 and 7.

The material layer of the flexible zones 10 and 11 connects to the side sections in the lower half (vertically) of the side parts 6 and 7. Preferably, the material layer of the flexible zones connects to each side sections' bottom edge 23 (in the lower part of the material). Preferably, the material layer of the flexible zone connects to the support section 9 at its bottom half (vertically) which in the figures is illustrated by position 24.

Thanks to the bellow-like design of the material layer in the flexible zones, the support device 9 will flex to a different extent relative to the side parts in the horizontal and vertical directions.

The material layers 18 and 19 in the flexible zones 10 and 11 are preferably more than a third thicker than the material layer's thickness in the middle part.

The present invention follows the hoof's and the frog's movement outward, inward, upward and downward regardless of movement differences and angular differences between the hoof's two side parts. This is especially advantageous in conjunction with use of the inventor's earlier invented and patented horseshoe which is sold under the brand name of Razer.

It has unexpectedly been discovered that a decreased risk of the pad being stretched apart is achieved if the support section 9 includes a first material layer 25 constituting the surface layer on the topside of the support section 9 and at least one second material layer 26 constituting the surface layer on the bottom side of the support section 9 and at least one intermediate, relatively softer material layer 27 positioned between the first material layer 25 and the second material layer 26. The first (top) layer of material 25 and the second (bottom) layer of material 26 are joined together in one layer at the merging point 28 to the flexible zones 10 and 11. This design achieves the unexpected technical effect that support section's 9 width increases during the stance phase. The increased width of the support section 9 is achieved by the intermediate layer 27 being compressed (becoming thinner) and that the distance between the merging points 28 thereby becomes longer. The increased width of the support section 9 means that the risk of being stretched apart decreases. In one preferred embodiment, the first material layer 25 and the second material layer 26 have a hardness with a shore number which exceeds 87 in the material layer and that the intermediate material layer 27 has a hardness with a shore number below 80. A nearly optimal performance is achieved if the shore number is 70. In alternative embodiments, however, it is conceivable that one or more layers of material 25, 26 and 27 have a shore number different from the ones mentioned above. The harder material in the first layer and the second layer achieve the characteristic of improving wear resistance during use.

In variants of the alternative embodiment, the first side part 6 and the second side part 7 include at least one first material layer 29, which forms the surface layer on the topside of the side parts 6, 7 and at least one second layer of material 30 which forms the surface layer on the bottom side of the side parts 6, 7 and at least one intermediate material layer 31 positioned between the first material layer 29 and the second material layer 30. In one preferred embodiment, the first material layer 30 and the second layer of material have a hardness with a shore number exceeding 87 and that the intermediate material layer 31 has a hardness with a shore number below 80. The harder material in the first layer and the second layer have the characteristic of improving wear resistance during use. A nearly optimal performance is achieved if the shore number of the intermediate material layer 31 is 70. This design achieves the technical effect of reducing vibrations that arise by a shoe being attached to the pad and the horse hoof. Vibrations arise because the back part of the shoe is not attached with seams and this causes vibrations which may propagate to the horse's hoof and cause damage (which may be difficult to find the cause of). In alternative embodiments, however, it is conceivable that one or more of the material layers 29, 30 and 31 have a shore number that differs from the ones mentioned above.

The relatively softer material layer 31 preferably extends from a position just behind the position of the rear seam of the shoe when the shoe and the support device are connected to the horse's hoof. The position may also be defined as just behind the widest part, in the hoof's transverse direction, of the pad.

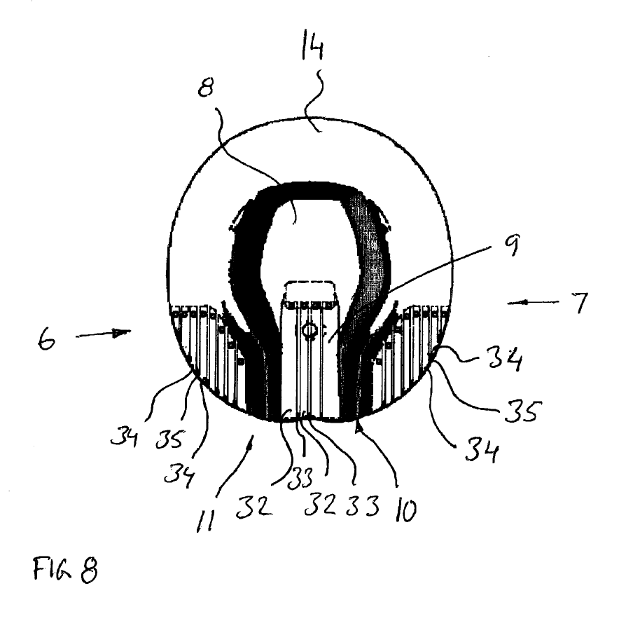

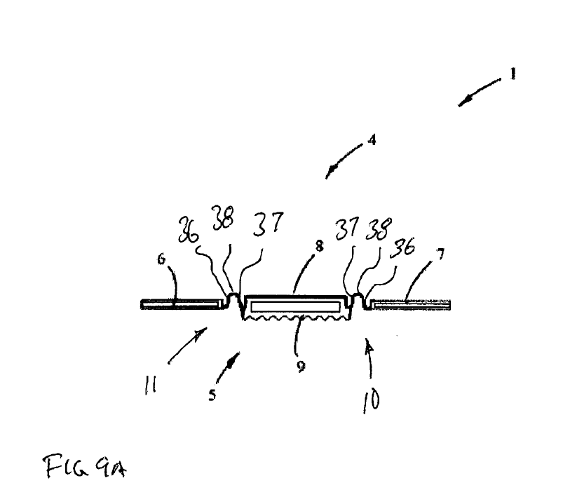

Referring to FIGS. 7 and 8, is shown, via hidden contours (contours that are not normally visible), how material layer 27 in a preferred embodiment is partitioned into at least two sections 32 (pockets or the like). These sections 32 are partitioned by at least one intermediate wall 33 (partition or the like) extending between the first material layer 29 and the second material layer 30. In the exemplifying embodiment shown in the figures, the material layer is divided into eight sections with intermediate walls. The number of sections and intermediate walls may vary within the scope of protection.

Referring again to FIGS. 7 and 8, is shown, via hidden contours how material layer 31 in one preferred embodiment is partitioned into at least two sections 34 (pockets or the like). The sections 34 are partitioned by at least one intermediate wall 35 (partition or the like) extending between the first material layer 29 and the second material layer 30. In the exemplifying embodiment shown in the figures, material layer 31 is divided into four sections 34 with intermediate walls 35. The number of sections 34 and intermediate walls 35 may vary within the scope of protection.

In alternative embodiments it is conceivable that the hardness of the intermediate material layer 27 in the support section 9 differ from the hardness of the intermediate material layer 31 in the side parts 6 and 7. It is further conceivable that at least one section 32 of material layer 27 has a different hardness than at least one second section 32 of material layer 27. In a corresponding manner, it is further conceivable that at least one section 34 of material layer 31 has a different hardness than at least one second section 34 of material layer 31. It is thus conceivable that each respective material layers' sections include multiple hardnesses (softnesses) than two up to the point that each section in each respective material layer 27 and 31 have a specific hardness (softness) which differs from the other sections.

The intermediate walls also have the technical effect of limiting, to some degree, changes in shape (form) in the rear area of the side parts 6 and 7 during a strain on these from the horse's hoof.

In an alternative embodiment, at least one of the intermediate material layers 27 and 31 may be comprised of a space, preferably enclosed, which contains at least one type of fluidic medium such as gas, combination of gases such as air, some type of liquid or mixture of liquids or a combination thereof.

In alternative embodiments, at least one of the material layers 29 and 30 in the side parts 6 and 7 are provided with one or more apertures in the direction toward the intermediate layer of a material of a relatively softer material that is included in the intermediate layer. The apertures have the technical effect of it improving the manufacturing process by allowing the infusion of the relatively softer material of the intermediate layer. The apertures allow the relatively softer material of the intermediate layer to stretch through at least one of the material layers 29 and 30. This has also unexpectedly been shown to have a positive effect associated with the application of adhesive or similar to the support device. The relatively harder material's glossy surface causes glue (adhesives) and the like to adhere more poorly to this material than to the relatively softer material.

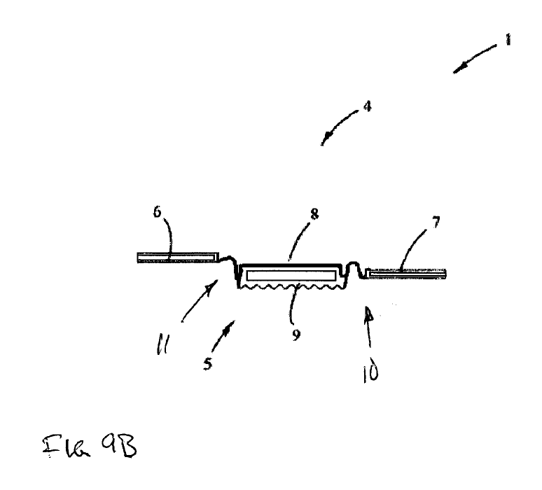

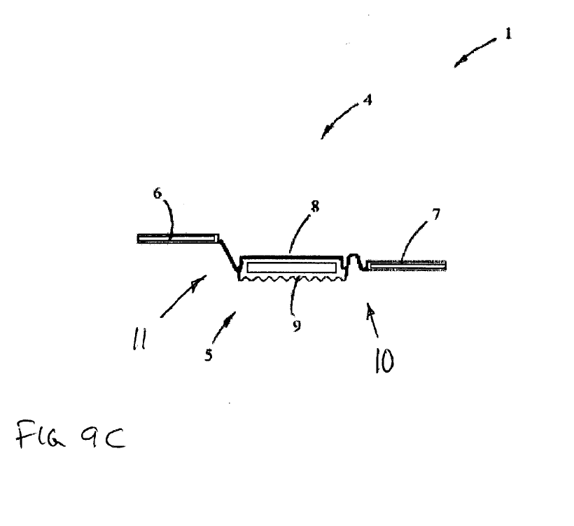

Referring to FIG. 9A and 9B, the function of the flexible bellow-shaped zones 10 and 11 is schematically shown. In the exemplary embodiment, the flexible zones have a bellow-shape. It is though conceivable that the shape differs in alternative embodiments. The bellow-shaped zones 10 and 11, according to the present invention, have a design that essentially allows for a maximum elastic spread of the support section relative to the side parts to be achieved. The bellow-shaped design includes (in an unaffected position) at least one essentially upwardly directed vertical section 36, at least one essentially vertically downward directed section 37 and an arc-shaped section 38 which connects the first essentially upwardly directed section 36 with the essentially downwardly directed section 38. A further unexpected technical effect is achieved by the material layer in the downwardly directed section 37 being secured in the lower half of the support device 9.

Referring to FIG. 9A, the pad-like support device is shown in its initial position. Referring to FIG. 9B, a variant is shown in which the underlying surface has affected part 6 in the upward direction. The flexible zone 10 allows part 6 to flex upward without part 6 essentially being moved in the direction towards the support device's 1 center. In FIG. 9B, the flexible zone has been partially stretched out. FIG. 9C shows the flexible zone in an essentially fully extended position. In a further stage (not shown in the figures), when the relative height in the vertical direction (in the figures) between part 6 and the support device's attachment point increases further, the fully extended flexible zone will cause part 6 to begin to twist (wrench) about the point of attachment of the bellow of the support section. The design should be compared with previously known designs of pads, where twisting of the corresponding parts such as part 6 and/or part 7 (in this patent application) starts directly or substantially directly. Known designs have nowhere near, or essentially nowhere near, a comparable flexibility as the design of the present patent application. During use, the design according to the present invention, allows mutual movement of the parts inherent in a hoof. Furthermore, the flexibility decreases the risk of the seam being pulled apart by the pad as is the case for known designs of pads. An equivalent functionality, flexibility, is also applicable for the side part 7 connected via zone 11. An equivalent functionality is essentially also achieved during a downward movement of the side part 6 and 7.

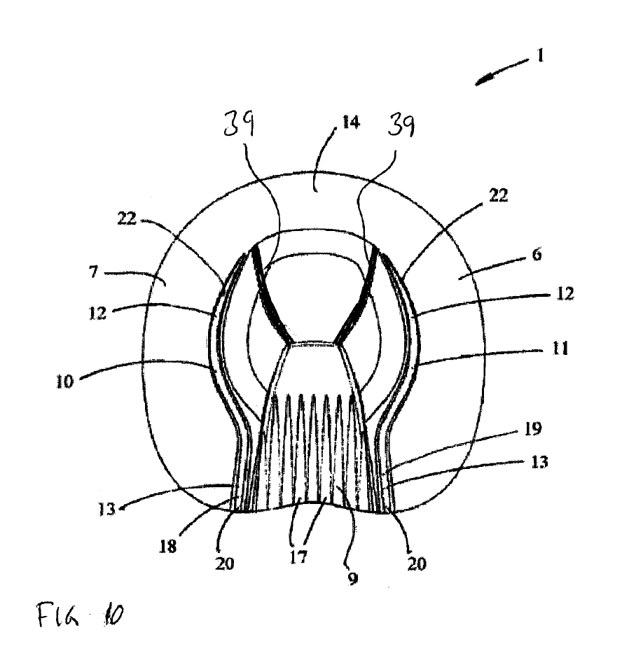

Referring to FIG. 10, an alternative embodiment of the support device is shown where it is provided with at least one first reinforcement 39. In the shown embodiment, the support device includes at least one first reinforcement 39 and at least one second reinforcement 39. In the exemplary embodiment, reinforcement 39 extends from the pad-like support device in the direction towards the front edge 14 of the pad-like support device. In alternative embodiments, the reinforcements may have a different extension. The reinforcements have the technical effect that they reinforce the center section and hold up the support section in the case where at least one hole is made in the center section. A hole may preferably be made if access to the underside of the hoof is necessary when the support device is connected to the hoof.

The material of the pad-like support device 1 consists preferably of a material that exhibits a good structural strength while at the same time having elastic properties. Suitably, polyurethane or another material with similar characteristics may be used in the pad-like support device 1 (an exemplifying material consists of Polyurethane Bayer 390X with a shore number of 93).

It is conceivable that another for the purpose suitable material be used in the pad-like support device. The pad-like support device may for example be manufactured by injection molding or die casting. These production methods are already known and this is why these manufacturing methods are not described in more detail in this patent application.

In the detailed description of the present invention, design details may have been omitted which are apparent to persons skilled in the art. Such obvious design details are included to the extent necessary so that the proper and full performance of the present invention is achieved.

Even if certain preferred embodiments have been described in detail, variations and modifications within the scope of the invention may become apparent for specialists in the field and all such are regarded as falling within the scope of the following claims. For example, it is conceivable in alternative embodiments that the center part (section) includes at least one through hole. It is conceivable that the pad-like support device's center section in its entirety consist of a hole. The first side part and the second side part have essentially the same thickness over their expanse. In alternative embodiments it is conceivable that the support device may include several parts which are joined in a manner suitable for the purpose. In alternative embodiments it is conceivable that the holes may consist of grooves or consist of a combination of grooves and holes.

The contact surfaces' shape allows the pad-like support device to preferably fit to more than one shoe size. The side parts 6 and 7, bottom side may further be provided with holes (air pads). The holes are preferably not through holes but consist of blind holes. The holes' cross-sectional shape may be oval, round or another for the purpose suitable cross-sectional shape.

The holes may also even have different cross-sectional sizes. The holes are intended to increase the cushioning characteristics of the material. The holes also minimize the risk of material being pressed out between the hoof 2 and horseshoe 3 in conjunction with hoof impact with the ground and during gait movement (during the impact phase and the stance phase). The reduced risk of material being pressed out depends on the material of the first side part 6 and the second side part 7 being compressed into the holes whereby the risk of material being pressed out between the hoof 2 and the horseshoe 3 decreases.

### Advantages of the Invention

A number of advantages are achieved with the present invention. The pad-like support device's springy (dampening, elastic) function allows the horse hoof during impact to function similar to a hoof's function during impact when the horse is unshod. A further advantage is that the risk of pressing in is essentially eliminated. A further advantage of the present invention is that the flexible zones reduce the pull on the shoe and the seam (nails) when rocks and uneven ground press the middle part in the upward direction. A still further advantage is that an effective dampening of the frog's ground impact is achieved thereby reducing the load (stress) on the horse's hoof, ligaments and joints. It is a further advantage of the present invention that it improves circulation. Because the frog's support essentially follows the frog's every movement, friction (abrasion) occurring between the pad and the frog on existing pads is minimized.

1. A pad-like support device (1) intended to be attached between a horse's hoof (2) and a horseshoe (3) comprised of at least one first side part (6), at least one second side part (7), at least one middle part (8) and a support section (9) for the frog, and at least one first flexible zone (10) and at least one second flexible zone (11) extending essentially along the pad-like support device's longitudinal direction, allowing the support section (9) and the middle part (8) to be flexibly arranged in the horizontal and vertical directions relative to the first side part (6) and the second side part (7) characterized by that the first side part (6) and the second side part (7) include at least one first material layer (29) constituting a surface layer on the topside of the side parts (6, 7) and at least one second material layer (30) constituting a surface layer on the bottom side of the side parts (6, 7) and at least one intermediate material layer (31) positioned between the first material layer (29) and the second material layer (30) of a relatively softer material than the material of the first material layer (29) and the second material layer (30) and that material layer (31) is partitioned into at least two sections (34) by at least one intermediate wall (35) that stretches between the first material layer (29) and the second material layer (30).

2. A pad-like support device (1) in accordance with claim 1 characterized by that the support section (9) includes at least one first material layer (25) constituting a surface layer on the top side of the support section (9) and at least one second material layer (26) constituting a surface layer on the bottom side of the support section (9) and at least one intermediate material layer (27) positioned between the first material layer (25) and the second material layer (26) of a relatively softer material than the material of the first material layer (25) and the second material layer (26).

3. A pad-like support device (1) in accordance with claim 1 characterized by that material layer (27) is partitioned into at least two sections (32) by at least one intermediate wall (33) extending between the first material layer (25) and the second material layer (26).

4. A pad-like support device (1) in accordance with claim 1 and characterized by that the first material layer (25) and the second material layer (26) have a hardness with a shore number exceeding 87 and that the intermediate material layer (27) has a hardness with a shore number below 80.

5. A pad-like support device (1) in accordance with claim 3 characterized by that the first material layer (25) and the second material layer (26) have a hardness with a shore number that lies in the interval of 91 to 94.

6. A pad-like support device (1) in accordance with claim 4 characterized by that the first material layer (25) and the second material layer (26) have a hardness with a shore number of 93.

7. A pad-like support device (1) in accordance with claim 1 and characterized by that the first material layer (29) and the second material layer (30) have a hardness with a shore number exceeding 87 and that the intermediate material layer (31) has a hardness with a shore number below 80.

8. A pad-like support device (1) in accordance with claim 1 and characterized by that at least one of material layer (29) and material layer (30) in the side parts (6, 7) include one or more apertures that allow for the relatively softer material in material layer (31) to stretch through at least one of the material layers (29, 30).

9. A pad-like support device (1) in accordance with claim 1 and characterized by that the first flexible zone (10) and the second flexible zone (11) consist of a bellow-shaped (accordion shaped) material layer.

10. A pad-like support device (1) in accordance with claim 1 and characterized by that the bellow-shaped design includes at least one essentially upwardly directed vertical section, at least one essentially vertically downward directed section and an arc-shaped section which joins the first essentially upwardly directed section with the essentially downwardly directed section.

11. A pad-like support device (1) in accordance with claim 1 and characterized by that the first flexible zone (10) and the second flexible zone (11) include a front zone part (12) and a rear zone part (13).

12. A pad-like support device (1) in accordance with claim 1 and characterized by that the flexible zones flexibility increases in the rearward direction.

13. A pad-like support device (1) in accordance with claim 1 and characterized by that the pad-like support device is made of polyurethane.
